(19) United States
(12) Patent Application Publication
(10) Pub. No.: US 2015/0059314 A1
(43) Pub. Date: Mar. 5, 2015

(54) ELECTRICALLY IGNITED AND THROTTLED PYROELECTRIC PROPELLANT ROCKET ENGINE

(71) Applicant: Digital Solid State Propulsion, Inc., Reno, NV (US)

(72) Inventor: Michael D. MCPHERSON, Reno, NV (US)

(21) Appl. No.: 14/473,708

(22) Filed: Aug. 29, 2014

Related U.S. Application Data
(60) Provisional application No. 61/871,767, filed on Aug. 29, 2013.

(51) Int. Cl. F02K 9/24; F02K 9/26

(52) U.S. Cl. CPC F02K 9/24; F02K 9/26
USPC 60/219; 60/254; 60/256

(57) ABSTRACT

According to one aspect, an apparatus and method for electrically igniting and throttling pyroelectric propellant, e.g., in a rocket engine, are provided. In one example, an apparatus includes an injector body for supplying an electrically ignitable propellant to a combustion chamber and a opposing electrodes. A first electrode may be included with the injector body and a second electrode positioned relative to the first electrode to cause ignition of the electrically ignitable propellant as the electrically ignitable propellant flows thereby.

### CROSS-REFERENCE TO RELATED APPLICATION

This application claims the benefit of priority to U.S. Provisional Ser. No. 61/871,767, filed on Aug. 29, 2013, entitled ELECTRICALLY IGNITED AND THROTTLED PYROELECTRIC PROPELLANT ROCKET ENGINE, which is hereby incorporated by reference in its entirety for all purposes.

### BACKGROUND

The disclosed embodiments relate generally to electrically ignitable propellants and rocket engines, and more specifically, to electrically ignited and throttled pyroelectric propellant rocket engines and methods for operating same.

### BRIEF SUMMARY

According to one aspect of the invention, an apparatus and method for electrically igniting and throttling pyroelectric propellant, e.g., in a rocket engine, is provided. In one example, an apparatus includes an injector body for supplying an electrically ignitable propellant to a combustion chamber and opposing electrodes disposed to charge and ignite the electrically ignitable propellant. For example, a first electrode may be included with the injector body and a second electrode positioned relative to the first electrode to cause ignition of the electrically ignitable propellant as the electrically ignitable propellant flows from the injector body by the second electrode.

In another example, a method is provided for electrically igniting and throttling pyroelectric propellant, e.g., in a rocket engine. The method includes injecting an electrically ignitable propellant to flow adjacent electrodes and selectively providing power to the electrodes so as to ignite the electrically ignitable propellant as it passes adjacent the electrodes.

The details of one or more embodiments of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

Non-limiting and non-exhaustive embodiments of the present invention are described with reference to the following figures, wherein like reference numbers refer to like parts throughout the various views unless otherwise specified.

FIG. 1 illustrates a center electrode injector system according to one example.

FIGS. 2A-2C illustrate a center electrode injector system having a splash plate according to another example.

FIGS. 3A and 3B illustrate a center electrode injector system having a circular electrode according to another example.

FIG. 4 illustrates a center electrode injector system having oppositely charged propellant streams according to another example.

FIG. 5 illustrates an exemplary computer system that may be used with or in communication with the exemplary electrode injector and rocket engine systems described herein.

### DETAILED DESCRIPTION

The description is presented to enable a person of ordinary skill in the art to make and use the various embodiments. Descriptions of specific devices, techniques, and applications are provided only as examples. Various modifications to the examples described herein will be readily apparent to those of ordinary skill in the art, and the general principles defined herein may be applied to other examples and applications without departing from the spirit and scope of the present technology. Thus, the disclosed technology is not intended to be limited to the examples described herein and shown, but is to be accorded the scope consistent with the claims.

According to one aspect of the present invention, systems and process are described using pyroelectric propellants, particularly electrically-controlled ignition and/or electrically-assisted combustion, digitally controlled (ignited and/or throttled) propellants, in lightweight engines with or without regeneratively cooled component designs. Embodiments and examples may include bipropellant engine designs (e.g., separate fuel and oxidizer) or monopropellant (e.g., compositionally optimized) rocket engines, or these in combination, all having distinct and novel benefits by use of the pyroelectric propellant characteristics of electrically-controllable start and stop, additionally controlled with flow control or variable power to yield throttled, adjustable thrust.

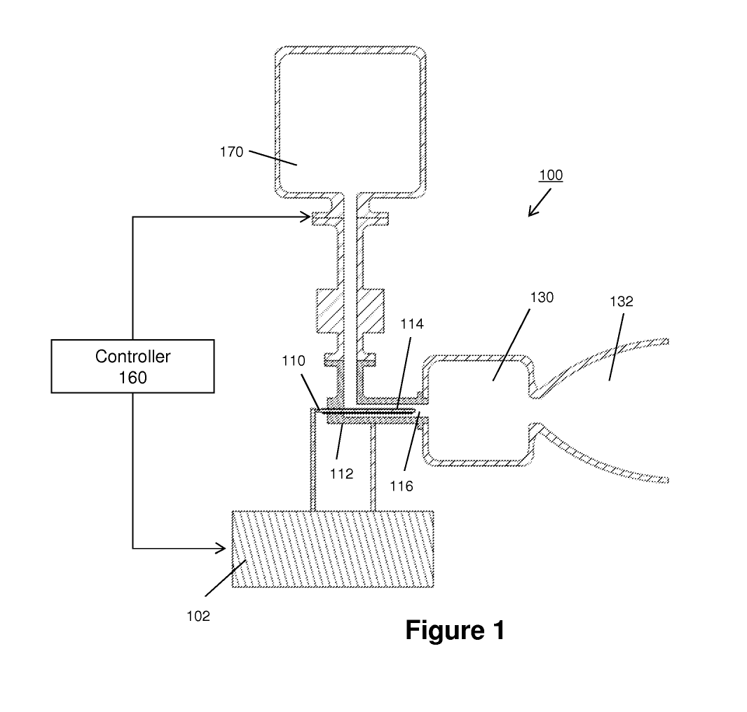

With reference to FIGS. 1-4, different modes of deployment for electrical, throttleable engines that use pyroelectric monopropellants or bipropellants are depicted. As monopropellants, a single formulation may be deployed in the examples, e.g., that do not undergo undesirable mix ratio (MR) shift under various conditions of pressure or flow rate through variable orifices. As bipropellants, separate streams of electrical fuel propellant or electrical oxidizer propellant can use the electrically ignitable and throttleable behavior, tailored to achieve higher performance than can be provided by monopropellant formulations via separate additions of fuels or oxidizer ingredients, yet are bound by mix ratio optimums for best performance.

The application of bipropellant or monopropellant rocket engines with pyroelectric propellants both have, as novel features, an electrically-controlled injector which also controls start and stop of the engine. Additionally, design features which include regeneratively-cooled heat exchanger components, such as combustion chambers, allow the use of robust and conventional materials of construction as compared to uncooled or radiatively-cooled designs requiring high-cost, high-temperature capable superalloys for best performance, albeit at reduced weight. Simple injector electrodes can be electrically controlled to vary combustion pressure and hence thrust of the engine, especially when coupled with mass flow control of propellant(s) through the electrode injector. The throttleability that results, with simple components and materials, advance the state of the art by simultaneously providing advantages of reduced hazards, reduced toxicity, and electric controllability provided by the pyroelectric propellants, with options for robust regeneratively-cooled engine components that actively mediate the high combustion temperatures that these high-performance pyroelectric propellants also provide, which may replace toxic alternatives such as hydrazine, with equivalent or better performance potential. The residence time of liquid propellant as it flows across, passed through, or over the “partially” energized electrodes can precondition/partially react, before entering the combustion chamber.

In certain aspects, monopropellant engines are improved by use of an electrically-controlled injector having both cathode (conventionally negatively charged) or anode (positively charged) structures, which eliminates granular packed catalyst sections or catalytically-active combustion chambers having high materials or manufacturing costs, pressure drop, reduced lifetimes, and limited on-off duty cycles. Simple designs for the monopropellant engines can therefore employ regeneratively-cooled chambers as a feature, mitigating use of high-cost materials which are required to meet temperature requirements when not enabled by use of the pyroelectric propellants with electrically-controlled injector grids. In lightweight designs, regeneratively-cooled features may not be required, as trades of cost versus performance for the intended application may prove beneficial for one over the other engine concept.

Additionally, in some examples, single-design regeneratively-cooled engines may employ either monopropellants or bipropellants, which can significantly expand upon mission of the rocket engine or flight vehicle. Duty cycles may therefore include monopropellant mode, or bipropellant mode, controllable by conventional valves and mass flow controllers, using a common electrically-controlled injector grid as one or multiple elements of cathode/anode structures combined as an injector. The flexibility of mono-propellant or bipropellant pyroelectric propellants to provide on-off duty cycles or thrust adjustability are therefore only limited by the volume of propellants available on the vehicle.

FIG. 1 illustrates a center electrode injector system 100 according to one example. In this example, a pyroelectric monopropellant is throttled via flow control and power variations, ignited at the end or tip of center electrode 110 having one electrical charge, with the opposing electrical charge placed on the outer electrode body 112. Propellant generally flows from a fuel tank 170 through an injector body 112 and through an ignition area 116, which comprises center electrode 110, which is partially insulated by insulator 114. As electrically ignitable propellant flows through the injector body 112, while electrical power from power supply 102 is supplied across the center electrode 110 and injector body 112, combustion occurs in combustion chamber 130 and exits through nozzle 132. System 100 may be throttled by either flow control of the pyroelectric propellant and/or the amount of power supplied to the electrodes 110, 112, which can be controlled dynamically by controller 160, which may be located remotely or with the electrode injector system 100.

As described in greater detail below, the exemplary electrode injector systems described herein may use one or more electrically ignitable propellants, that is, propellants that are ignited and/or sustained by electrical power therethrough. Such propellants are described, for example, in U.S. patent application Ser. Nos. 7,958,823 and 8,317,953, and U.S. Publication Nos. 2011/0259230 (Ser. No. 12/989,639) and 2011/0067789 (Ser. No. 12/993,084), which relate to the use of solid or plastisol propellant ingredients which may be in-common to mono- or bipropellant liquids or gels in these novel applications in controllable rocket engines. These references are incorporated by reference in their entirety for all purposes.

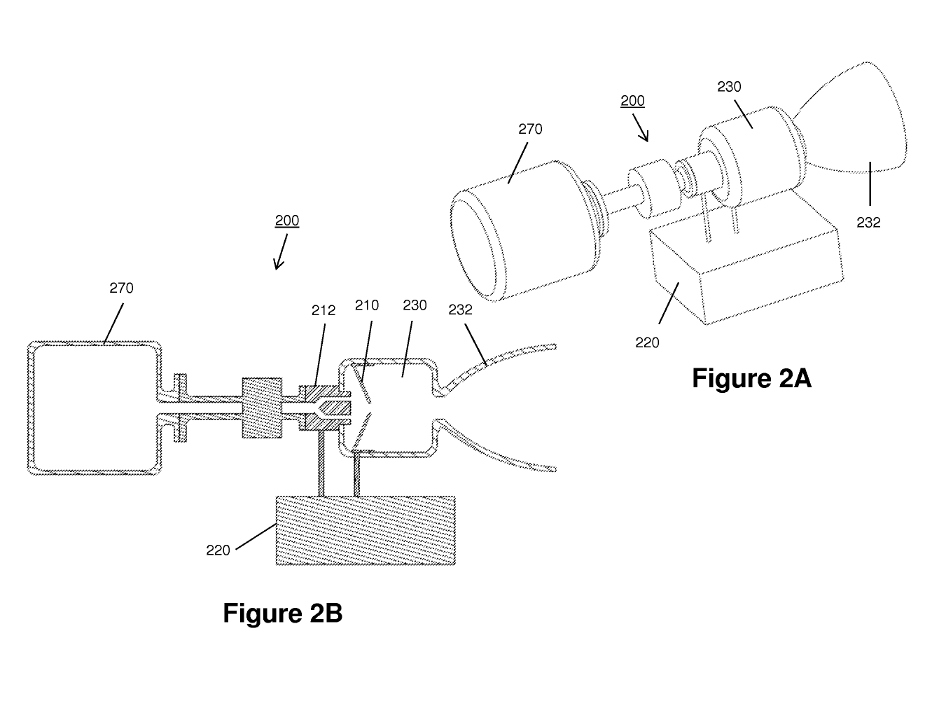

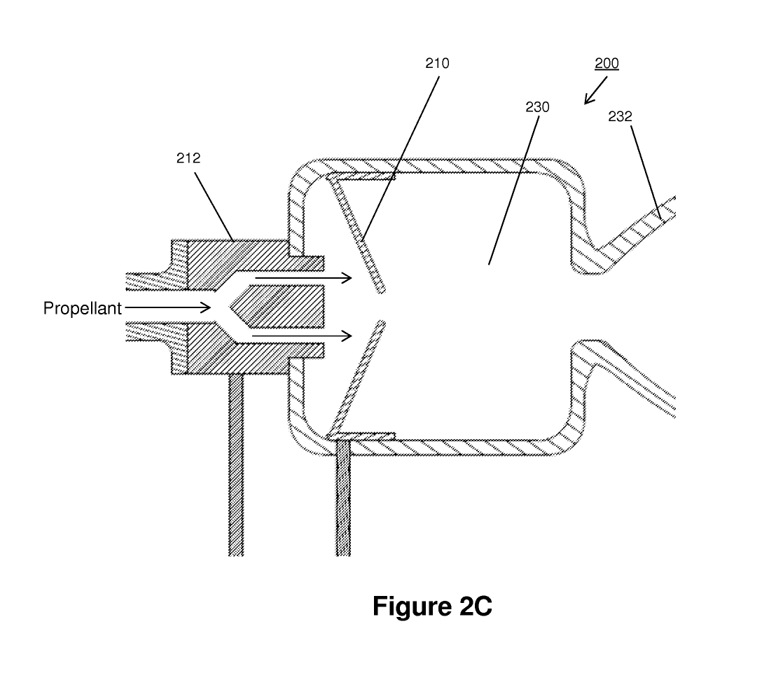

FIGS. 2A-2C illustrate a center electrode injector system 200 according to another example. In particular, FIG. 2A illustrates a perspective view of an electrode injector system 200, FIG. 2B illustrates a cross-sectional view of system 200 exposing a splash plate ignition arrangement therein, and FIG. 2C illustrates the splash plate ignition system of system 200 in greater detail.

In this example, a pyroelectric mono-propellant or bipropellant is throttled via flow control and power variations, ignited upon impingement with the splash plate 210 fixed as a component of combustion chamber 230. In other examples, splash plate 210 could be positioned outside or combustion chamber 230, e.g., at the distal end of the injector body 212. In this example, pyroelectric propellant stream(s) from fuel tank 201 are given an electrical charge as they pass through the injector body 212 via the power supply 220, and the opposing charge placed on the combustion chamber splash plates 210, causes ignition and combustion of the propellant. As seen more clearly in FIG. 2B, propellants are provided an electrical charge and flow through an injector body 212 to impact the oppositely-charged splash plate 210. The charged propellant igniting upon contact with splash plate 210 and combusting to gas products in the combustion chamber 230 and exiting the nozzle 232, thereby providing propulsive thrust. Similarly to the previous example, a controller (not shown here) may be used to control the flow of propellant and/or the electrical charge provided to the system, thereby providing control over the thrust of the system.

The splash plate is provided as an example for the concept of including design features whereby the propellant is in contact with oppositely charged grids, plates, or other features to allow ignition and modulation via electrical control and/or flowrate. More upstream location of charged design features may be used to incrementally sensitize the propellant up to the threshold of ignition, as desired, to optimize performance of the engine—with additional downstream charged surfaces used as required to increase efficiency and response times of engine operation.

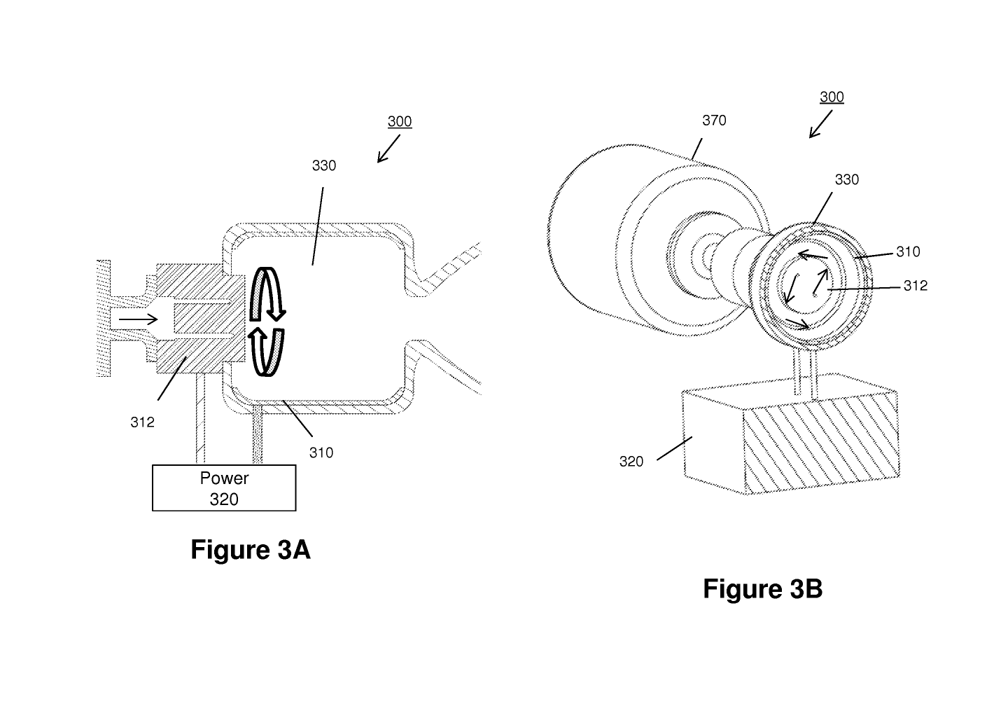

FIGS. 3A and 3B illustrate a center electrode injector system 300 according to another example, including a cross-sectional view and a perspective view of a swirl electrode configuration between injector body 312 and circular electrode 310, which are provided opposite charges by power supply 320. In this example, a pyroelectric mono-propellant or bipropellant from tank 370 is throttled via flow control and power variations, ignited in this case upon impingement with a circular electrode 310, with propellant(s) injected by injector body 312 to create circular flow. In particular, injector body 312 is formed to inject propellant into combustion chamber 330 to have a generally circular flow therein. A second circular electrode 310 is positioned around the inner wall of the combustion chamber to cause combustion of the propellant upon contact. Advantages of this example, and the circular flow within combustion chamber 330, including relatively high combustion efficiencies and shorter overall lengths of the combustion chamber 330 (and thus engine).

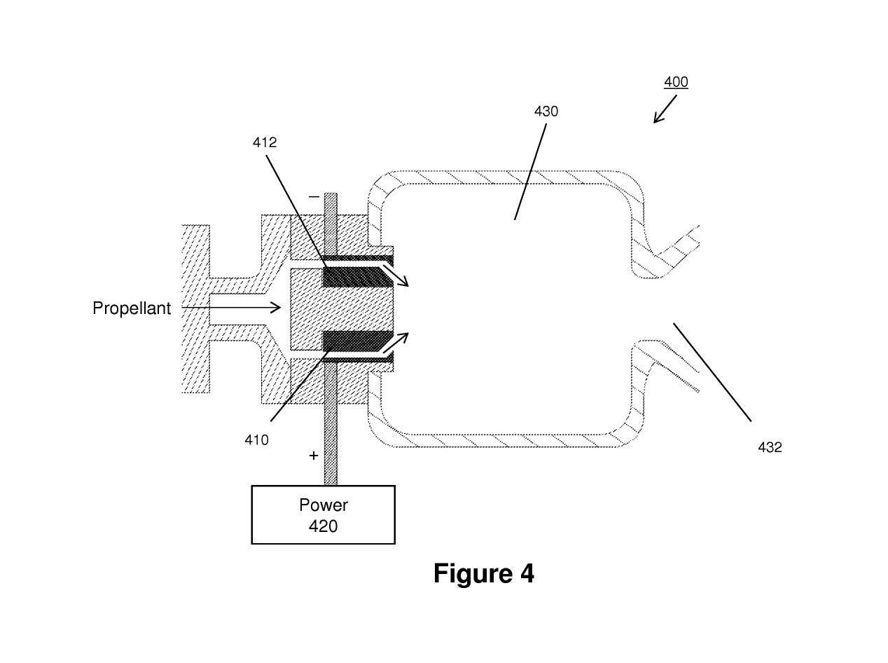

FIG. 4 illustrates a center electrode injector system 400 according to another example. In this example, a pyroelectric propellant is throttled via flow control and power variations, ignited upon impingement of oppositely charged propellant streams. For example, the propellants are ignited and combusted in the forward part of the chamber 430, having been oppositely charged while passing through the injector bodies 410 and 412, which are charged by power supply 420. Hot combustion products exiting the nozzle 432 provide propulsive thrust. Continuous propellant streams are given opposing electrical charge to provide ignition.

The different embodiments illustrated as FIGS. 1-4 provide various advantages and performance characteristics as discussed generally below. It will be understood by those of skill in the art that other variations and modification consistent with the description herein are possible and contemplated. Further, various embodiments discussed above, can be operated in a number of different modes. In some examples, a bipropellant Mode includes using separate fuel and oxidizer in the engine system. A bipropellant mode generally simplifies, relative to monopropellant modes, injectors (e.g., generally lower cost of manufacturing for unique injector spray patterns), provides throttleability and stop-start by use of pyroelectric propellants with ‘green’ reduced toxicity (e.g., compared to propellants currently used in the alkylhydrazine fuel family, or nitrogen oxide family of oxidizers, which are noteworthy for their toxicity), higher performance, reduced handling hazards such as impact, friction, or electrostatic sensitivity, retaining use of regeneratively cooled designs for simplicity and reduced cost.

In another example, a monopropellant mode includes using a compositionally optimized propellant. Monopropellant modes may reduce or eliminate the need for high-temperature superalloys (e.g., high-cost Hastelloy, Waspaloy, or Inconel-family materials) when employing higher performance propellants having features as above, providing novel regeneratively cooling capability. Monopropellant modes may also reduce or eliminate the need for catalysts in combustion chambers or separate catalyst pack sections, which reduce service life when considering pressure drop, catalyst performance decay (such as sintering), high cost, stringent manufacturing requirements, limited duty cycles, added weight, limited throttleability, inefficient combustion, and the like.

Additionally, in other examples, Multi-, or “Tri-propellant” modes may be used. In common regeneratively-cooled designs, electrically-controlled electrode grid injectors can function in continuous variations of mono- or bipropellant flow, which can augment throttleability when combined with flow control and electric controls to the injector grid.

Gas Generator Mode: a monopropellant decomposition gas output may be directed to provide pressurization elsewhere on the vehicle having such designs, doing work to transport fluids, actuate valves or movable components, doing such work to the benefit of the overall mission. For example, where a tailored output of gas species are desired instead of high temperature, high velocity flux optimum for rocket propulsion, these same concepts may be employed, not to provide thrust for propulsive motion, but to provide pressurization gases to perform various duties onboard a craft where propulsive elements may also be located.

Additional combustion efficiencies may result when chambers are optimized for use of these concepts, further reducing inert weight, increasing thrust, and widening throttleability and expanding mission utility in common regenerative engine designs or in radiatively-cooled designs.

Aspects of the described embodiments herein overcome key shortcomings to both conventional mono- and bipropellant rocket engines, not readily apparent to those of ordinary skill in the art. The combinatorial features of reduced manufacturing cost, regenerative designs, or alternatively radiatively-cooled engine designs, catalyst elimination, performance enhancement, toxicity and hazards reduction, are significant—readily and immediately transferable to demonstration phase activity. The multi-phase performance of these electrically-controlled liquid propellants, as bipropellants or monopropellants, include a wide range of deployment options that can significantly enhance mission effectiveness when deployed.

These exemplary novel applications benefit both space and defense missions, and may have application generally to chemical propulsion technologies. Applications also exist in commercial activities, particularly in subsurface energetics use in oilfields, mining, or in undersea applications, to provide energetics to do work via their high temperatures, rapid deflagration and gas generation, or as tunable liquid explosives.

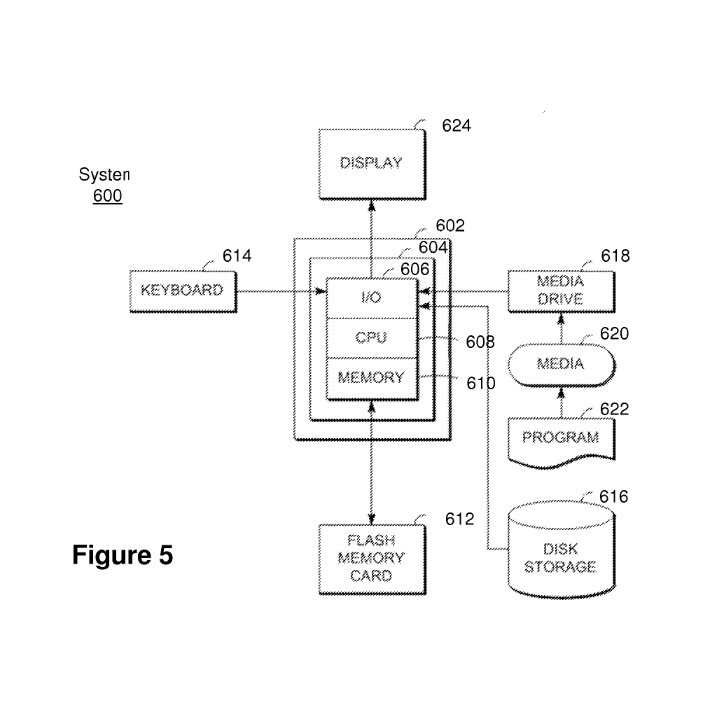

FIG. 5 depicts an exemplary computing system 600 configured to perform any one of the above-described processes, e.g., relating to controlling and throttling fuel and/or power to an exemplary engine. Further, the exemplary computing system may be included entirely or in part with a rocket engine, vehicle including a rocket engine, or with a peripheral device operable to communication and/or control a rocket engine. In this context, computing system 600 may include, for example, a processor, memory, storage, and input/output devices (e.g., monitor, keyboard, disk drive, Internet connection, etc.). However, computing system 600 may include circuitry or other specialized hardware for carrying out some or all aspects of the processes. In some operational settings, computing system 600 may be configured as a system that includes one or more units, each of which is configured to carry out some aspects of the processes either in software, hardware, or some combination thereof.

FIG. 5 depicts computing system 600 with a number of components that may be used to perform the above-described processes. The main system 602 includes a motherboard 604 having an input/output (“I/O”) section 606, one or more central processing units (“CPU”) 608, and a memory section 610, which may have a flash memory card 612 related to it. The I/O section 606 is connected to a display 624, a keyboard 614, a disk storage unit 616, and a media drive unit 618. The media drive unit 618 can read/write a computer-readable medium 620, which can contain programs 622 and/or data.

At least some values based on the results of the above-described processes can be saved for subsequent use. Additionally, a non-transitory computer-readable medium can be used to store (e.g., tangibly embody) one or more computer programs for performing any one of the above-described processes by means of a computer. The computer program may be written, for example, in a general-purpose programming language (e.g., Pascal, C, C++, Java) or some specialized application-specific language.

Various exemplary embodiments are described herein. Reference is made to these examples in a non-limiting sense. They are provided to illustrate more broadly applicable aspects of the disclosed technology. Various changes may be made and equivalents may be substituted without departing from the true spirit and scope of the various embodiments. In addition, many modifications may be made to adapt a particular situation, material, composition of matter, process, process act(s) or step(s) to the objective(s), spirit or scope of the various embodiments. Further, as will be appreciated by those with skill in the art, each of the individual variations described and illustrated herein has discrete components and features that may be readily separated from or combined with the features of any of the other several embodiments without departing from the scope or spirit of the various embodiments. All such modifications are intended to be within the scope of claims associated with this disclosure.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above described embodiment, method, and examples, but by all embodiments and methods within the scope and spirit of the invention.

We claim:

1. An apparatus for electrically igniting and throttling pyroelectric propellant, the apparatus comprising:
an injector body for supplying an electrically ignitable propellant;
a combustion chamber; and
electrodes, wherein a first electrode is included with the injector body and a second electrode is positioned relative to the first electrode to cause ignition of the electrically ignitable propellant.

2. The apparatus of claim 1, further comprising, a power supply for providing power to the electrodes.

3. The apparatus of claim 2, wherein power is selectively provided to the electrodes to throttle combustion.

4. The apparatus of claim 1, further comprising a flow controller for controlling the flow of electrically ignitable propellant passing through the injector body.

5. The apparatus of claim 4, wherein the flow controller is selectively controlled to throttle combustion.

6. The apparatus of claim 1, wherein one of the electrodes forms at least part of a splash plate.

7. The apparatus of claim 1, wherein one of the electrodes forms a circular electrode, and wherein the injector body is configured to create a circular flow of injected propellant.

8. The apparatus of claim 1, wherein the electrodes are configured to provide two streams of the electrically ignitable propellant, wherein each of the two streams are oppositely charged.

9. The apparatus of claim 1, wherein the electrically ignitable propellant comprises a monopropellant.

10. The apparatus of claim 1, wherein the electrically ignitable propellant comprises a bipropellant.

11. A rocket engine comprising the apparatus of claim 1.

12. A method for electrically igniting and throttling pyroelectric propellant, the method comprising:
injecting an electrically ignitable propellant to flow adjacent electrodes; and
selectively providing power to the electrodes so as to ignite the electrically ignitable propellant as it passes adjacent the electrodes.

13. The method of claim 12, further comprising supplying power to the electrodes.

14. The method of claim 12, further comprising selectively providing power to the electrodes to throttle combustion.

15. The method of claim 12, further comprising controlling the flow of electrically ignitable propellant passing through the injector body.

16. The method of claim 15, wherein the flow controller is selectively controlled to throttle combustion.

17. The method of claim 12, wherein one of the electrodes forms at least part of a splash plate, and at least a portion of the electrically ignitable propellant flows incident to the splash plate.

18. The method of claim 12, further comprising injecting the electrically ignitable propellant in a circular flow path.

19. The method of claim 12, wherein the electrically ignitable propellant comprises a monopropellant.

20. The method of claim 12, wherein the electrically ignitable propellant comprises a bipropellant.
